(19) United States
(12) Patent Application Publication
(10) Pub. No.: US 2012/0137362 A1
(43) Pub. Date: May 31, 2012

(54) COLLABORATIVE SECURITY SYSTEM FOR RESIDENTIAL USERS

(75) Inventors: Antonio Manuel Amaya Calvo, Madrid (ES); Ivan Sanz Hernando, Madrid (ES); Jeronimo Nunez Mendoza, Madrid (ES)

(73) Assignee: TELEFONICA, S.A., Madrid (ES)

(21) Appl. No.: 13/266,391

(22) PCT Filed: Apr. 19, 2010
(86) PCT No.: PCT/EP2010/002383

§ 371 Date: Feb. 15, 2012

(30) Foreign Application Priority Data
Apr. 28, 2009 (ES) P200901107

(51) Int. Cl. G06F 21/00

(52) U.S. Cl. 726/22

(57) ABSTRACT

The invention relates to a collaborative system for security information exchange between users, based on the fact that a determined function (whether storing or processing) is spread out at different points of a network to achieve more scalable processing and storing factors than if they were all done at one and the same point.

The invention proposes architecture with a centralized element, referred to as “Central Device”, through which said user devices share information with the remaining users to finally activate an alert or rule it out.

### FIELD OF THE ART

The invention belongs to the sector of IP communications, and specifically focusing on the security of users in their access to Internet.

### STATE OF THE ART

In a world in which Internet services are at their peak and in which users are provided with increasingly more possibilities, such as e-commerce, home banking, personal communications or administrative tasks, to mention just a few examples, criminal acts occurring in the analog world transferred to the digital world of Internet, such as: fraud attempt, system intrusion, identity theft, etc., arise simultaneously.

Due to the high economic amounts being handled today and the increase of the dependence of users on new services, the number of criminal acts grows exponentially. This in turn creates wealth in companies of the security sector, offering products to end users so that they themselves can put in place the means to protect themselves. Typical products being offered are:
Firewalls: As elements which allow the user to configure which Internet connections he can make and which connections he can make from Internet to his home.
Antivirus, Antimalware (systems for detection malicious software): To try to identify the malicious code that is installed in the users' computers.
Intrusion detection systems (IDS): To try to identify malicious traffic circulating in the network.

Specifically, in the field of intrusion detection systems, products in charge of monitoring network traffic in search of intrusion attempts or suspicious activities (in some cases with different capacities) are being offered. These services are being offered both for companies and for residential users, certain minimal technological know-how and security that an average user does not have being needed in their management and interpretation.

For the purpose of freeing the user from this management burden, there are various companies offering services aimed at monitoring security systems and they can even perform correlations between (making decisions depending on events which occur) and learning from the reports they receive from different clients or sources.

US patent 2005/0257264 describes a system for generating and distributing alerts in a cooperative environment. Said distribution is done based on a structure (Bloom Filters) in which the different detected alerts are linked together. The system describes said structure and the mechanisms of sharing in a collaborative environment.

Unlike that patent, the solution proposed by the present invention is based on a Central Device which stores all the alerts generated by the Home Devices, being capable of responding to the petitions made by said devices about a determined event. The Home Devices can complete the analyses made with the information obtained in their own network with the information of other Home Devices, increasing the unwanted traffic or intrusion detection capacity.

This manner of acting, in which there is a mediating device (Central Device), allows a higher degree of confidence in the system as it is the latter that validates the information.

Patent US 2004/0205419 describes a system comprising a plurality of client devices and at least one server. It is furthermore specified that if abnormal events are detected in one of the client devices, an alert is sent to the end users and the server of the network system is informed.

This is another concept that differs from that of the present invention and it is based on what is known as a SIM, multiple probes distributed among clients sending the information to a central server and the latter performs the necessary correlations and identifications.

In the present invention, however, the client devices perform the correlations and they rely on the central device to know the criticality thereof. Furthermore, the system proposed in US 2004/0205419 focuses on the attack of a computer virus and not on other network attacks, such as that proposed by the present invention.

### Technical Problem Considered

There are currently various products which allow having a centralized view of the security status of a network, but they need to have access to all the traffic which passes through the network. The following stand out, among many others:
SIM (Security Information Management). Systems in charge of collecting and analyzing the information of security of the network, generating alerts in the event of detecting malicious activities.
Anomaly Detectors. Tools in charge of monitoring all the network traffic in search of unusual activities that can be indicative of attack attempts.

For the case of an ISP (Internet Service Provider) which may provide service to several million clients, this involves two problems:
A topology problem, which consists of finding the point or the minimum set of points to monitor in order to have access to all the traffic.
A second problem is the power needed in the equipment for monitoring in real time all the traffic passing through the ISP (to and from the clients thereof).

These problems often mean that the service is not actually implemented (due to a lack of viability of a technical solution) and the problem is transferred to user dependencies and control.

For the purpose of facilitating the management task of monitoring systems for end users, various services aimed at monitoring security systems are being provided. These services can even perform correlations between and learning from the reports they receive from the different clients, although no service which allows a user (client/company) to know the events that are occurring in the network and to make the decision of how to act depending on said information without having to assign the security management to a third party is known.

Furthermore, the fact that the management is finally done by a user means that, despite the many attacks occurring daily on the Internet, the user does not have real-time access to this privileged information and he only has knowledge of the attacks that are occurring in his network or of very specific attacks subsequently published in forums.

The current monitoring services deployed in different clients only use the information compiled and analyzed by their own systems, without taking into account the information compiled by other clients. This architecture poses several problems which are solved by the proposed solution:
Basing the analyses only on the activity received in the network itself prevents the detection of certain signs of attacks, such as for example initial port scanning because these attacks may go unnoticed as normal connection attempts. For example, if a connection attempt with respect to a specific port is detected in a system, even though it is not a very usual port, it does not offer enough information so as to mark it as a possible attack attempt. However, if the system can know that connection attempts with respect to the same port have been made, in addition to our systems, in other systems simultaneously, this could be indicative of an attempt to locate vulnerable servers and, therefore, it could act against the origin of said connections before the actual attack is launched.
Not knowing whether the origin of an activity detected in the client network has previously been classified as an attack in another client necessarily means that the attack must occur in order to take measures against said origin because there was not enough information beforehand which allowed suspecting said origin.
The existence of a Central Device which receives all the alerts generated by the different client devices allows performing an analysis as a whole, allowing the detection of attacks which, separately, would have gone unnoticed. For example, if an intruder performs an attack against a client, this attack will be identified in the Central Device which, due to any activity of said attacker in any other client, will immediately report it either automatically or at the request for information from the actual client.

In addition, the fact that a user who has no technical knowledge has to make the final decision means that the interpretation of the messages provided by the security systems is generally wrong. As a practical example, an empirical study conducted on user groups to detect the reasons for which phishing attacks (attacks based on obtaining confidential personal user data by means of social engineering) work can be consulted at http://people.seas.harvard.edu/˜rachna/papers/why_phishing_wor ks.pdf. In said study it was observed that the users often make incorrect decisions even when they have help tools due to the fact that they lack the knowledge of how computer systems work and they do not understand how security systems and indicators work. Furthermore, because of this lack of information, it is risky (since there is a high probability of error) to allow a security system to act autonomously since the partial information (only from the section of the network observed by the system) that is available is insufficient for making decisions, which can be radical (network connection cut-off, for example) and hinder (since it does not allow visiting any web pages that the system considers to be fraudulent, for example) the daily use of the Internet access service.

### Proposed Solution

### Object of the Invention

The solution provided by the invention consists of a collaborative system based on neural networks of security information exchange. Neural networks are based on the fact that a determined function (whether storing or processing) is spread out at different points of a network to achieve more scalable processing and storing factors than if they were all done at one and the same point.

Based on this manner of acting, there is a series of devices distributed among the users of the service which perform tasks of detecting attacks and local threats against their environment and share said information with the remaining users through a central device which is what, based on its programmed logic, decides the criticality of the shared information.

Due to the fact that the system is fueled by the information extracted from different points of the network, the identification of the attacks and threats is greater than that provided by an isolated device which knows in a biased manner the attacks which are occurring.

The invention is carried out with the development of two devices: a centralized server referred to as “Central Device”, which, in addition to acting as an update point of the client devices, will contain the information of the “neuron” nodes existing in the neural network and of the information that they themselves have requested and a client device (“neuron” node) referred to as “Home Device” which is installed in the home of the client:
The Home Device has two configuration types:
   Basic: in which it provides an interface for communication with the security devices of the client by way of receiving security anomalies, serving as an interface with the neural network (see FIG. 2: Home Device Configurations).
   Advanced: The device furthermore has modules which allow supervising the network such that the client does not need previously installed attack detection modules (see FIG. 2: Home Device Configurations).

In both modalities, the Home Device has a decision-making correlation device (which can be dynamically updated from the Central Device). When the Home Device detects signs of an attack it can, if it does not have enough local data to make a decision, it makes a query to the Central Device about the data that caused these signs: the type of activity it detected, who originated the activity, etc. The Central Device will communicate to it which other Home Devices (“neurons”) requested information about the same sign, thus allowing the Home Devices to exchange information about the detected activity. The Home Device could this finally activate an alert or rule it out. In the event that an alert is activated, the Home Device will communicate the alert to the Central Device for the purpose of updating the knowledge bases (security policy) that is distributed to the Home Devices, including the data (typology) of the type of attack detected.

The configurations of the types of security anomalies activating the request for more information in the Home Device are homogenous in all the Home Devices.

Once the alert is generated in the Home Device, it can be treated according to the criteria that are defined: warning through SMS, mail, voice message, by console, or through an automatic action on the traffic which cuts off, for a pre-configured time, the flow of communication originating from or addressed to the IP (Internet Protocol) address which has been detected as the source of the attacks.

The Home Device will store, for a time period defined by a central policy, information about which other nodes (other Home Devices, or neurons of the network) it knows. Thus, after an initial training period, the network can support itself, even in the event of a temporary crash of the Central Device.

The Home Device will be deployed in bridge mode (mode in which the device is situated as if it was the communications cable and is invisible for the remaining equipment), the device being in the middle of the communications of the client such that were it desired to act on any type of traffic, it can cut off said traffic or allow it to interact with other devices of the client.
The Central Device will perform the following actions:
Update the correlation modules of the Home Device.
Store the security anomalies and in the event that a client asks for information about any of said anomalies, sending it information about which Home Devices have reported said anomalies.

The mode in which the Central Device will record the security anomalies is immediate through a common policy deployed in the Home Devices, since these will only ask (transmitting the information through a pre-established communication channel between the Central Device and the different Home Devices) about actions that are considered risky. Therefore these questions of the Home Device will form the database of risky events in the network and can in turn be sent (once the information that may identify the attacked devices has been eliminated in order to preserve user anonymity) to the different Home Devices that have asked about them. This mode of acting would form the basis of the neural network (see FIG. 4: Functional Description).

FIG. 4 shows a diagram in which the sequence of events causing an alert of the System can be seen. At first, (1), one of the Home Devices (N3) detects a suspicious activity. A query is made about said activity to the Central Device, and the central server returns (2) the list of “neurons” (Home Devices) that have recently made queries about the same activity. In the example of the figure, said list is made up of Home Devices N2 and N4. N2 asks the other Home Devices (3) for information about the activity detected in their local networks. N3 and N4 answer (4) with the information. If N3 decides that the activity is malicious, it generates a local alert and informs the nodes of the cache thereof (N2 and N4) that it has generated a local alert. If said information is enough to generate a local alert in N2 and/or N4, the information continues to spread through the network (5): N2 will warn N1 and N4 will warn N5. It would be possible for the alert to be generated in one of the Home Devices and not in others, in which case only the device concerned would spread the alert. Said spreading activity continues (6) until all the nodes of the network have been warned, or until all the nodes receiving the alert rule it out (because it does not apply locally).

The risk of this functionality is that users can simulate attacks in their networks for the purpose of poisoning the Central Device with false data. However, this problem is minimized because the level of confidence in an alert or suspicious behavior depends on the number of neurons (Home Device) of the network that have reported a suspicious behavior. Therefore the compromise or malicious use of a limited number of Home Devices will not compromise the integrity of the network. The Central Device will furthermore have the capacity to distribute confidence policies which are constructed depending on the credibility generated by the contrast of the data received from the different Home Devices. Thus the neural network will only make decisions of generating an alert status for a determined event if such event has been reported by a determined number of Home Devices and based on confidence statuses of the device which will be based on the times they have participated in reports corroborated by other Home Devices.

### BRIEF DESCRIPTION OF THE DRAWINGS

FIG. 1 depicts the general diagram of the Home and Central Devices.

FIG. 2 shows the Home Device Configurations.

FIG. 3 illustrates the components of the Home and Central Devices.

FIG. 4 depicts the functional description showing the sequence of events causing an alert.

### DETAILED DESCRIPTION OF THE INVENTION

### Preferred Embodiment

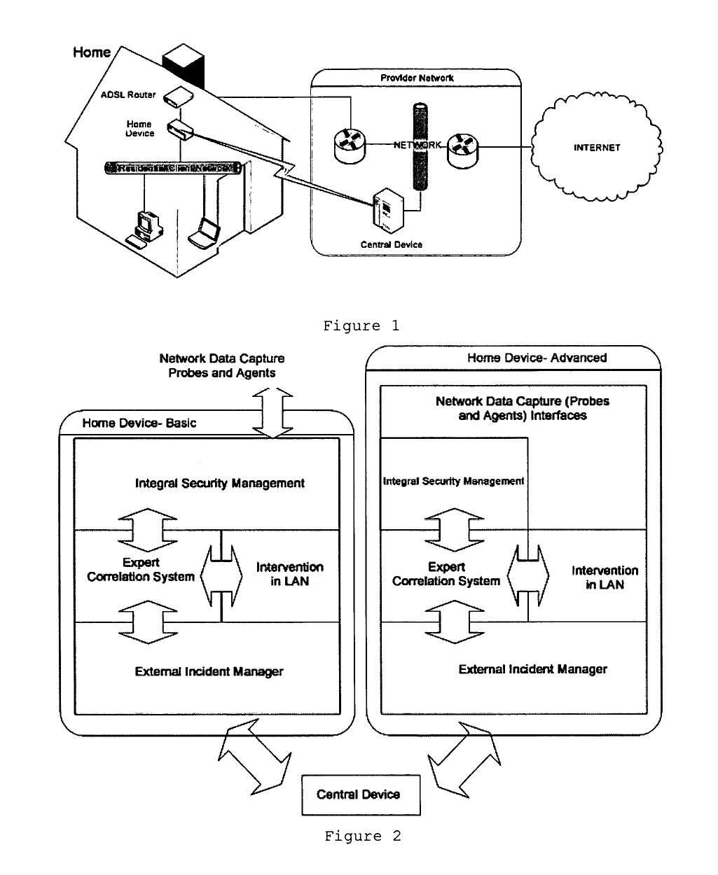

The developed system consists of two main two components (see FIG. 1: General diagram).

The diagram of FIG. 1 shows the installation of the Home Device in bridge mode in client dependencies and which could therefore make the decision to cut off determined traffic originating from/addressed to Internet, and the Central Device installed in the ISP, and which would maintain communication with the different elements of the neural network (the different Home Devices). The union marked as (1) would represent the logical communication between the Home and Central Devices, regardless of the communications network that is used.
Home Device: This component is a piece of equipment that will be installed in the homes of ISP clients. The equipment will have at least two network interfaces and will be installed in bridge mode between the Local Area Network (LAN) of the client and the access to the Internet of said client.

FIG. 2 depicts the Home Device Configurations which, as previously indicated, could have two possibilities, i.e., a so-called Home Device-Basic, in which the possible security monitoring elements that the client has are respected and an interface for communication with said elements will be offered in order to receive the security events, and another so-called Home Device-Advanced, which will have its own security monitoring systems.
Central Device: This component will be installed in the ISP installations and will serve as a collector of information about the prior queries made by the Home Devices. Information about new threats, new correlation rules or new malicious agents can additionally be spread from the Central Device to all the registered Home Devices.

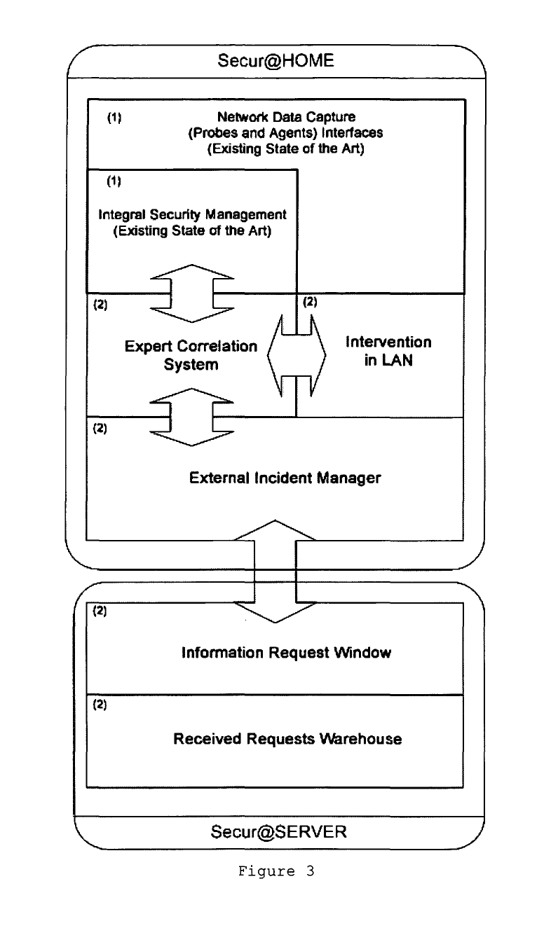

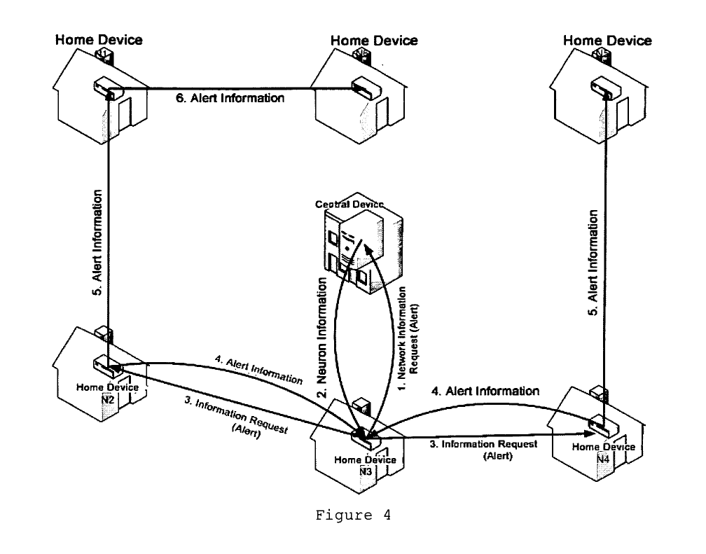

FIG. 3 shows the different modules forming both the Home Device and the Central Device. The existing technology on which the devices are supported is labeled as (1) and the developments necessary for complying with the specifications that have been defined are labeled as (2).

The Home Device is made up of an Integral Security Management module (already existing in the current state of the art) expanded with the following new components:
Expert Correlation System
External Incident Manager
Intervention in LAN

Each of these components is described below in greater detail.
The Expert Correlation System Module is in charge of making decisions about the security status of the network based on the traffic observed therein. It will use as inputs the network events stored by the Integral Security Management System (obtained therefrom in real time) and the prior status of the system, which will be kept in the External Incident Manager Module. As a result of a decision, the Expert Correlation System may decide, in real time, to cut off a connection to prevent more serious damage. It will furthermore report the result to the External Incident Manager Module so that said result can be used in future decisions and can be shared with remote Home Devices. This component integrates the logic part of a “neuron” of the neural network.
The External Incident Manager Module has a dual function: On one hand, it will store for a configurable time period the results of previous evaluations, and on the other hand it will make said results available for the Expert Correlation System Module and for those other authorized devices requesting it. The entire system thus acts like a distributed neural network (in which each Home Device is a neuron of the network). Each evaluation in a device involves iteration in the neural network, and the External Incident Manager Module is in charge of both the network feedback and of maintaining the status. This module can request information from the Central Device about at which other points of the network an incident such as the one that is being considered (by type of incident or by the parties considered therein) has been observed. Once the information about which other Home Devices have requested the same information is received from the Central Device, the Home Device can connect directly with the other Home Devices in order to extend the information available therein if necessary. Information that may be considered confidential is therefore not stored in the Central Device.
The Intervention in LAN Module is the interface of the Expert Correlation System Module with the Local Area Network. This module has the capacity to cut off a network connection in real time.

### INDUSTRIAL APPLICATION OF THE INVENTION

A commercial service intended for residential clients could be elaborated in which the following could be marketed:
The Home Device
The neural network connection service, in summary, the interaction with the Central Device.

The initial exploitation could be reinforced with different strategically distributed Home Devices such that they assure optimal service, regardless of the number of existing subscribers and which is gradually improved as the number of service subscribers increases.

1. A collaborative security system for residential users comprising a series of devices distributed among the users of the service, referred to as Home Devices, which perform tasks of detecting attacks and local threats against their environment, said user devices share information with the remaining users through a centralized server, referred to as Central Device which, based on its programmed logic, decides the criticality of the shared information.

2. The collaborative security system for residential users according to claim 1, wherein the Home Device has a correlation device for making decisions which can be dynamically updated from the Central Device.

3. The collaborative security system for residential users according to claim 2, wherein when the Home Device detects signs of an attack and does not have enough data to make a decision, it can make a query to the Central Device about the data that caused these signs, and the Central Device will communicate to it which other Home Devices requested information about the same sign, thus allowing the Home Devices to exchange information about the detected activity, to finally activate an alert or rule it out.

4. The collaborative security system for residential users according to claim 3, wherein when the Home Device activates an alert, it will communicate said alert to the Central Device for the purpose of updating the knowledge bases distributed to the Home Devices, including the data (typology) of the type of attack detected.

5. The collaborative security system for residential users according to claim 1, wherein the Home Device is installed in bridge mode between the user's local network and the public network, such that it is invisible for the remaining equipment of the user, it does not interact with other devices of said user and it can perform active filtering (elimination of incoming or outgoing traffic) of the user network.

6. The collaborative security system for residential users according to claim 2, wherein the Home Device is made up, in addition to an Integral Security Management module, of the following components:
Expert Correlation System
External Incident Manager
Intervention in LAN.

7. A collaborative security system for residential users comprising a series of devices distributed among the users of the service, referred to as Home Devices, each of which has at least one network interface for a public computer interconnection network such as Internet, said Home Devices including at least one integral security management module intended for tasks of detecting attacks and local threats against their environment, characterized in that each of said user devices shares information with the remaining users through a centralized server, referred to as Central Device installed in the facilities of the provider of said computer interconnection network, and intended for collecting information about the prior queries made by the Home Devices and which, based on programmed logic, decides the criticality of information received, and in that said Home Device further comprises the following interconnected modules:
an Expert Correlation System Module in charge of making decisions about the security status of the network based on the traffic observed therein;
an External Incident Manager Module intended for storing the results of previous evaluations for a configurable time period and making said results available for the Expert Correlation System Module; and
an Intervention in Local Area Network Module with capacity to cut off a network connection in real time and which provides an interface for the Expert Correlation System Module with the local area network.

8. The collaborative security system for residential users according to claim 7, wherein said Expert Correlation System Module for making decisions can be dynamically updated from the Central Device.

9. The collaborative security system for residential users according to claim 7, characterized in that said Central Device has a knowledge base which is updated from any alert generated by a Home Device.

10. The collaborative security system for residential users according to claim 7, characterized in that the Central Device is adapted for spreading information about new threats, new correlation rules or new malicious agents to all the Home Devices connected thereto.

11. The collaborative security system for residential users according to claim 7, characterized in that the Home Device is installed in bridge mode between a user's local network and a public network, such that it is invisible for the remaining equipment of the user, it does not interact with other devices of said user and it can perform active filtering (elimination of incoming or outgoing traffic) of said user network.

12. A method for providing collaborative security for residential users comprising a series of devices distributed among the users of the service, referred to as Home Devices, each of which has at least one network interface for a public computer interconnection network such as Internet and said Home Devices including at least one integral security management module intended for detecting attacks and local threats against their environment, comprising storing all the alerts generated by the Home Devices in a Central Device installed in the facilities of the provider of said computer interconnection network, and responding from this Central Device to the petitions made by said Home Devices about a determined event such that when the Home Device detects signs of an attack and does not have enough data to make a decision, it can make a query to the Central Device about the data that caused these signs, and the Central Device will communicate to it which other Home Devices requested information about the same sign, thus allowing the Home Devices to exchange information about the detected activity including the data (topology) of the type of attack detected, to finally activate an alert or rule it out.
